(19) United States
(12) Patent Application Publication
(10) Pub. No.: US 2026/0213858 A1
(43) Pub. Date: Jul. 23, 2026

(54) STORAGE MEDIUM, INFORMATION PROCESSING DEVCE, AND INFORMATION PROCESSING METHOD

(71) Applicant: KABUSHIKI KAISHA TOSHIBA, Kawasaki-shi (JP)

(72) Inventors: Daisuke UCHIDA, Yokohama Kanagawa (JP); Kentaro TANIGUCHI, Kawasaki Kanagawa (JP)

(73) Assignee: KABUSHIKI KAISHA TOSHIBA, Kawasaki-shi (JP)

(21) Appl. No.: 19/449,979

(22) Filed: Jan. 15, 2026

(30) Foreign Application Priority Data
Jan. 23, 2025 (JP) 2025-009611

(51) Int. Cl. H04B 17/318; H04B 17/391

(52) U.S. Cl. CPC H04B 17/318; H04B 17/391

(57) ABSTRACT

According to one embodiment, a non-transitory computer-readable storage medium storing a computer-executable program that, when executed, causes the computer to perform following steps of acquiring structural information of a radio wave irradiation area, setting at least one transmission point and at least one reception point within the irradiation area, calculating the number of first paths within radio wave paths between the at least one transmission point and the at least one reception point, and outputting reception status information of the at least one reception point based on the number of the first paths.

### CROSS-REFERENCE TO RELATED APPLICATIONS

This application is based upon and claims the benefit of priority from Japanese Patent Application No. 2025-009611, filed Jan. 23, 2025, the entire contents of which are incorporated herein by reference.

### FIELD

Embodiments described herein relate generally to a storage medium, an information processing device, and an information processing method.

### BACKGROUND

In mobile communication systems, an appropriate placement of transmitters (also referred to as site design) is required to perform stable communication. Among mobile communication systems, private 5G systems, which have become widespread in recent years, sometimes employ distributed antenna systems to expand a communication area. A distributed antenna system includes a master unit connected to a base station via a cable such as an optical fiber, and remote units connected to the master unit via cables such as optical fibers.

The master unit distributes a signal received from the base station to the remote units. Remote units radiate the same signal as a radio wave since remote units are placed as transmitters, the private 5G system can be used in indoor environments where a radio wave is difficult to reach, such as buildings, as well as in outdoor environments like stations and stadiums.

For site design, it is necessary to investigate a reception status of a private 5G area while changing positions of the remote units serving as transmission points. In a case where the private 5G area is an indoor environment, a large number of rooms or obstacles increases radio wave reflection and scattering. This increases the number of radio wave paths between a transmission point and a reception point, leading to longer times required to determine the reception status.

### BRIEF DESCRIPTION OF THE DRAWINGS

FIG. 1 is a block diagram illustrating an example of a distributed antenna system according to a first embodiment.

FIG. 2 is a plan view illustrating an example of a communication area for the distributed antenna system according to the first embodiment.

FIG. 3 is a block diagram illustrating an example of the information processing device according to the first embodiment.

FIG. 4 illustrates an overview of a simulation of a reception strength according to the first embodiment.

FIG. 5 illustrates an overview of the simulation according to the first embodiment.

FIG. 6 illustrates an example of a color map showing a received power according to the first embodiment.

FIG. 7 illustrates another example of the color map according to the first embodiment.

FIG. 8 illustrates an example of a correspondence relationship between the number of paths (linear value) and a received power according to the first embodiment.

FIG. 9 illustrates an example of a color map showing the number of paths (logarithmic value) according to the first embodiment.

FIG. 10 illustrates an example of a correspondence relationship between the number of paths and a received power according to the first embodiment.

FIG. 11 illustrates another example of the correspondence relationship according to the first embodiment.

FIG. 12 illustrates an example of a table written to a memory according to the first embodiment.

FIG. 13 is a flowchart illustrating an example of processing according to the first embodiment.

FIG. 14 is a block diagram illustrating an example of an information processing device according to a second embodiment.

FIG. 15 is a block diagram illustrating an example of an information processing device according to a third embodiment.

FIG. 16 illustrates an example of a communication area according to the third embodiment.

FIG. 17 shows a plan view of an example of a communication area according to the third embodiment.

FIG. 18 shows a plan view of another example of the communication area according to the third embodiment.

FIG. 19A illustrates an example of a communication area including transmission points according to a modified example.

FIG. 19B illustrate another example of the communication area according to the modified example.

### DETAILED DESCRIPTION

Embodiments will be described below with reference to the drawings. In the following descriptions, a device and a method are illustrated to embody the technical concept of the embodiments. The technical concept is not limited to the configuration, shape, arrangement, material or the like of the structural elements described below. Modifications that could easily be conceived by a person with ordinary skill in the art are naturally included in the scope of the disclosure. To make the descriptions clearer, the drawings may schematically show the size, thickness, planer dimension, shape, and the like of each element differently from those in the actual aspect. The drawings may include elements that differ in dimension and ratio. Elements corresponding to each other are denoted by the same reference numeral and their overlapping descriptions may be omitted. Some elements may be denoted by different names, and these names are merely an example. It should not be denied that one element is denoted by different names. Note that “connection” means that one element is connected to another element via still another element as well as that one element is directly connected to another element. If the number of elements is not specified as plural, the elements may be singular or plural.

In general, according to one embodiment, a non-transitory computer-readable storage medium storing a computer-executable program that, when executed, causes the computer to perform following steps of acquiring structural information of a radio wave irradiation area, setting at least one transmission point and at least one reception point within the irradiation area, calculating the number of first paths within radio wave paths between the at least one transmission point and the at least one reception point, and outputting reception status information of the at least one reception point based on the number of the first paths.

### First Embodiment

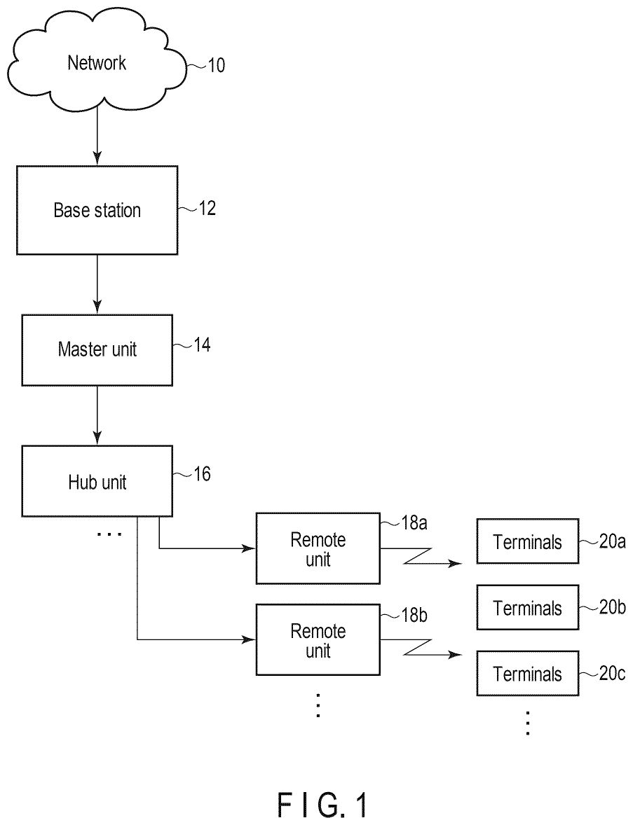

FIG. 1 is a block diagram illustrating an example of a distributed antenna system as an example of a mobile communication system that is site designed using an information processing device according to a first embodiment. The distributed antenna system includes a base station 12 connected to a network 10 via a cable such as an optical fiber. The base station 12 is connected to a master unit 14 via a cable such as an optical fiber. The master unit 14 is connected to a hub unit 16 via a cable such as an optical fiber. The hub unit 16 is connected to remote units 18a, 18b, . . . via cables such as optical fibers. The remote units 18a, 18b, . . . are discretely placed in a communication area of the distributed antenna system. In a case where there is no need for individual distinction, each of the remote units 18a, 18b, . . . is collectively referred to as a remote unit 18.

The hub unit 16 divides a signal from the master unit 14 into signals and transmits the signals to each of the remote units 18a, 18b, . . . . The remote unit 18 comprises a wireless circuit and an antenna for transmission and reception. A signal from the base station 12 is supplied to the remote units 18. A signal from the base station 12 is radiated by the remote units 18. Radio waves radiated from the remote units 18 are received by terminals 20a, 20b, . . . . In a case where there is no need for individual distinction, each of the terminals 20a, 20b, . . . is collectively referred to as a terminal 20. The terminals 20 are movable. The number of the terminals 20 may be singular.

Each of the remote units 18 is also referred to as a transmission point. By appropriately placing the remote units 18, the distributed antenna system can radiate transmission signals into the communication area at low cost without establishing base stations 12. The information processing device according to the first embodiment outputs information that allows to detect the overall reception status of the communication area. Based on this information, a designer of the distributed antenna system can place the remote units 18 to ensure a favorable overall reception status in the communication area.

In the distributed antenna system, the remote units 18 radiate radio waves with the same cell ID. Even if a terminal 20 receives radio waves from different remote units 18, since they have the same cell ID, no interference occurs in the received signals. If the remote units 18 respectively radiate radio waves with different cell IDs, interference occurs in the received signals at terminals receiving radio waves from different remote units 18.

An example of the distributed antenna system is not limited to the example shown in FIG. 1. The remote units 18 may be connected to the hub unit 16 in a cascade configuration or in a star configuration. A plurality of hub units 16 may be connected to the master unit 14. The hub units 16 may be connected to the master unit 14 in a cascade configuration or in a star configuration. A plurality of master units 14 may be connected to the base station 12. The master units 14 may be connected to the base station 12 in a cascade configuration or in a star configuration. Instead of providing the hub unit 16, the remote units 18 may be directly connected to the master unit 14. The remote units 18 may be connected to the master unit 14 in a cascade configuration or in a star configuration.

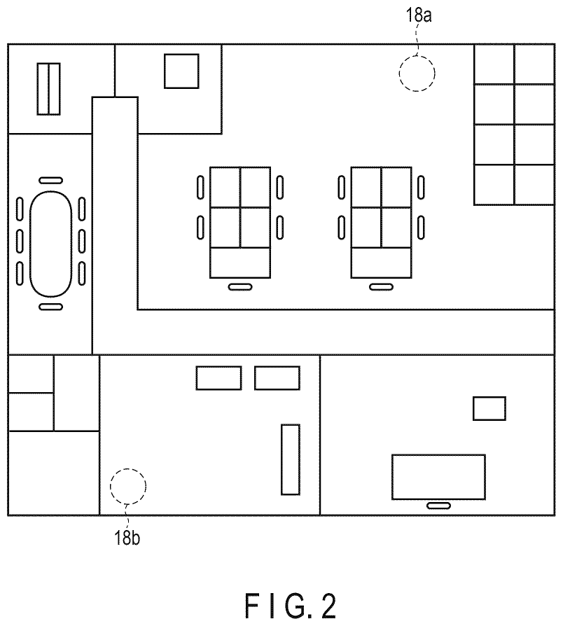

FIG. 2 is a plan view illustrating an example of the communication area for the distributed antenna system. FIG. 2 shows an example of the communication area in an indoor environment. Walls and fixtures exist within the indoor environment. Depending on their position, shape, and material, walls and fixtures can act as at least one of a reflecting object that reflects a radio wave, a penetrating object through that a radio wave penetrates, a shielding object that blocks a radio wave, or a diffracting object that diffracts a radio wave. Within the communication area including reflecting objects, penetrating objects, shielding objects, and diffracting objects, an indirect wave propagates in addition to a direct wave with line of sight. The indirect wave includes a reflected wave, a transmitted wave, a diffracted wave, and a wave resulting from combinations of at least two of these three wave types. The number of indirect waves is infinite. A site design involves placing remote units 18 so that reception points set within the communication area can comprehensively receive radio waves from the remote units 18 with good quality.

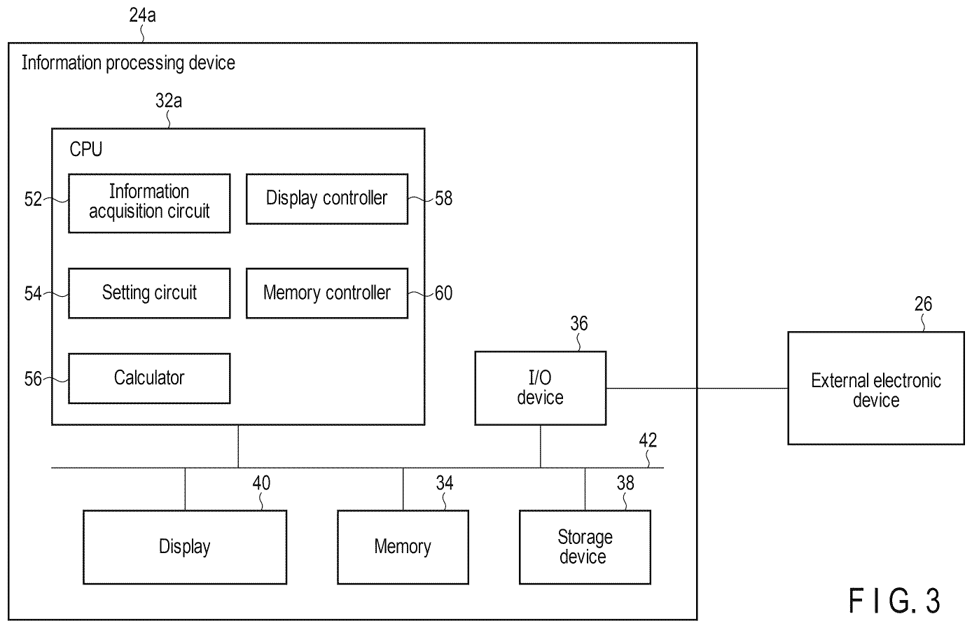

FIG. 3 is a block diagram illustrating an example of an information processing device 24a according to the first embodiment used for the site design. An external electronic device 26 is connected to the information processing device 24a via wireless or wired means. The electronic device 26 inputs structural information of the communication area, such as that shown in FIG. 2, to the information processing device 24a. The structural information includes information representing the position and shape of the communication area. The structural information also includes information representing the position, shape, and material of at least one of the reflecting object, the penetrating object, the shielding object, and the diffracting object affecting radio wave propagation within the communication area.

The information processing device 24a includes a CPU 32a, a memory 34, an input/output device (I/O device) 36, a storage device 38, and a display 40. The CPU 32a, the memory 34, the I/O device 36, the storage device 38, and the display 40 are interconnected via a bus line 42.

The I/O device 36 is connected to the electronic device 26 via wireless or wired means. The memory 34 is a high-speed volatile storage device, such as DRAM or SRAM. The storage device 38 is a large-capacity nonvolatile storage device, such as an SSD. The storage device 38 stores programs executed by the CPU 32a. The programs include a site design assistance program that outputs information useful for determining the placement of remote units 18. The programs are read from the storage device 38 and written to the memory 34 when power is applied to the information processing device 24a. The CPU 32a functions as an information acquisition circuit 52, a setting circuit 54, a calculator 56, a display controller 58, and a memory controller 60 by executing the site design assistance program stored in the memory 34.

Processing for the site design may be realized by hardware blocks that realize the functions of each unit shown in FIG. 3, instead of being realized by the CPU 32a via software. The CPU 32a may be configured by one or more CPUs. Instead of the CPU 32a, processing circuits such as a microprocessor, a graphics processing unit (GPU), an application specific integrated circuit (ASIC), a field-programmable gate array (FPGA), or a combination of these processing circuits may be used. The information processing device 24a may be connected to a server via a network. The processing for the site design may be executed by the server.

The information acquisition circuit 52 acquires structural information input from the electronic device 26. The setting circuit 54 detects the shape and position of the communication area based on the structural information and sets candidate points (hereinafter referred to as transmission candidate points) for the placement of each of the remote units 18 within the communication area. The calculator 56 sets reception points within the communication area and calculates an indicator representing the reception status of a radio wave at each of the reception points. Each reception point receives radio waves radiated from the remote units 18.

An example of the indicator is the number of primary paths among radio wave paths in communication links between the transmission points and the reception points. A primary path is a path where a received power at a reception point is at least a certain power level. The communication links include a path of a direct wave and a path of other than the direct wave (also referred to as a multipath). The multipath includes at least one of the reflected wave, the transmitted wave, and the diffracted wave, or at least two of the reflected wave, the transmitted wave, and the diffracted wave. For a path of the reflected wave, the received power decreases as the number of reflections increases. For a path of the transmitted wave, the received power decreases as the number of transmissions increases. For a path of the diffracted wave, the received power decreases as the number of diffractions increases. In a multipath environment, the received power decreases as the number of reflections, the number of transmissions, and the number of diffractions increase.

The primary paths of the indirect wave include a path of the reflected wave in which the number of reflections is not larger than a first value, a path of the transmitted wave in which the number of transmissions is not larger than a second value, a path of the diffracted wave in which the number of diffractions is not larger than a third value, and a path of mixed waves in which a total of the number of reflections, the number of transmissions, and the number of diffractions is not larger than a fourth value. The first value, the second value, the third value, and the fourth value may be equal to each other or different from each other. An example of the first value, which is a criterion for the number of reflections on determining whether or not a path is the primary path, may be two, three, etc. Note that in propagation modeling when simulating a multipath environment, propagation models based on the reflected wave assume the reflected wave in which the number of reflections is five to ten.

By using the number of the primary paths instead of the number of paths for all radio waves assumed to be in the communication link as the indicator, an amount and a time of calculation of the indicator can be reduced.

While the setting circuit 54 changes the transmission candidate points, the calculator 56 calculates the indicators for the reception points. The memory controller 60 writes identification information or positions of the transmission candidate points, identification information or positions of the reception points, and the indicator in connection with the identification information or positions in the memory 34. The display controller 58 displays the indicators for all reception points on the display 40. One example of a display mode is displaying them as a table in connection with the identification information or positions of the transmission candidate points, the identification information or positions of the reception points, and the indicator. Another example of the display mode is displaying them as a color map indicating values of the indicators for all reception points for a given transmission candidate point by color.

Designers of the distributed antenna system can look at the table or the color map to determine where to place the remote units 18 within the communication area to achieve the best overall reception status for the communication area. Designers use this information to perform the site design.

Next, the reason for using the number of primary radio wave paths at a reception point as the indicator for the site design will be explained.

In mobile communication systems, the site design is critical to perform stable communication. Communication stability is determined based on the reception status within the communication area. The reception status is represented by various indicators such as a reception strength (or received power), a delay time, a throughput, an SNR (signal-to-noise ratio), and a propagation loss. Among these indicators, the reception strength is the easiest indicator to obtain via simulation. The site design aims to ensure good reception status across the entire communication area while minimizing the number of base stations and antennas.

For the site design of the distributed antenna system, it is desirable to place the receivers within the communication area and measure the reception strengths of radio waves by receivers while changing the positions of the remote units 18. However, significant time and effort is required to actually measure the reception strengths by the receivers while changing the positions of the remote units 18. Instead of actual measurement, it is possible to model the communication area environment and calculate the reception strengths at the reception points within the communication area through simulation.

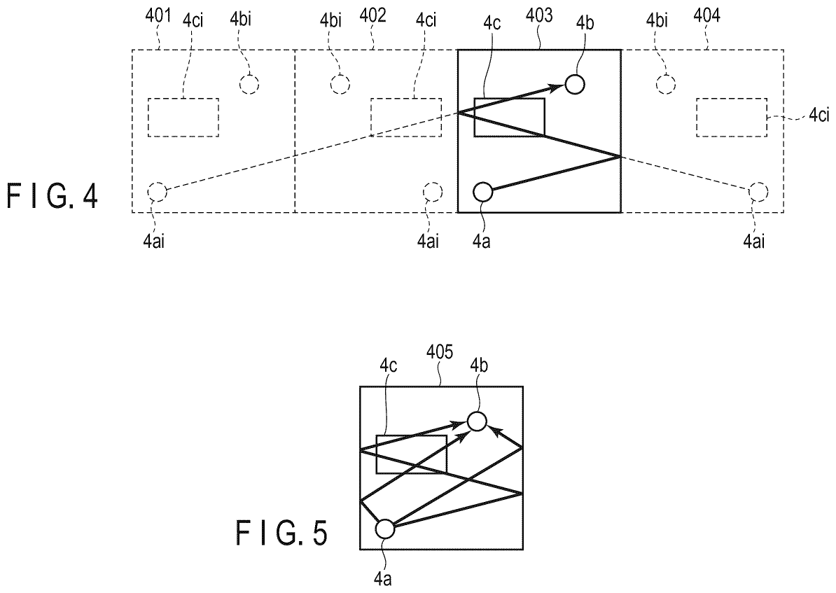

Simulation can be performed using geometric optical methods such as a ray tracing method. FIG. 4 and FIG. 5 illustrate an overview of the simulation according to the first embodiment. FIG. 4 is an example of a plan view of the communication area. FIG. 5 is another example of a plan view of the communication area. As shown in FIG. 4, a real space 403 including a transmission point 4a, a reception point 4b, and an obstacle 4c is defined within the communication area. The obstacle 4c is at least one of the reflecting object, the penetrating object, the diffracting object, and the shielding object. The planar shape (x-y plane shape) of the real space 403 is rectangular as one example, but may also be square. An example of the real space 403 is an entire floor of a building. Four edges defining the shape of real space 403 are wall surfaces. An image space, line-symmetrical with respect to the real space 403, is defined above, below, to the left, and to the right of the real space 403 for each of the four edges of the real space 403. The image space includes an image transmission point 4ai, an image reception point 4bi, and an image obstacle 4ci that are line-symmetric with respect to the transmission point 4a, the reception point 4b, and the obstacle 4c, respectively. Similar to the real space 403, for each of the four edges defining the shape of the image space, further image spaces line-symmetric with respect to the image space are defined above, below, to the left, and to the right of the image space. The image spaces can be defined in an infinite number.

FIG. 4 shows an example in which an image space 402 that is line-symmetric to the real space 403 with respect to a leftmost edge of the four edges that define the shape of the real space 403 is defined on the left side of the real space 403, an image space 404 that is line-symmetric to the real space 403 with respect to a rightmost edge of the four edges that define the shape of the real space 403 is defined on the right side of the real space 403, and a further image space 401 that is line-symmetric to the image space 402 with respect to a leftmost side of the four sides that define the shape of the image space 402 is defined on the left side of the image space 402.

When the image spaces are defined around the real space, a path (ray) of the radio wave in the communication link from the image transmission point 4a to the reception point 4b is traced. While there are an infinite number of indirect wave paths in the communication link, the number of primary paths is finite. Focusing on the reflected wave as one example of the indirect wave, in a case where the number of reflections for the reflected wave to be traced is large, the image spaces and image transmission points 4ai will increase exponentially, and the number of paths to be traced will also increase exponentially. Furthermore, considering a three-dimensional space, image spaces are also defined along a z-axis direction, causing the number of paths to be traced to increase even further.

The number of image spaces to be defined is arbitrarily determined depending on the desired number of paths to trace. In the case of tracing the primary path among paths within a communication link, the number of image spaces is limited to a finite number. For example, in the case of tracing a reflected wave path with the number of reflections not larger than two, following image spaces are defined. Four image spaces adjacent to the real space, which are respectively above, below, to the left, and to the right of the real space are defined. Four image spaces respectively at the upper-right, the upper-left, the lower-left, and the lower-right of the real space are defined. An image space further above the image space above the real space is defined. An image space further below the image space below the real space is defined. An image space further to the left of the image space adjacent to the left of the real space is defined. An image space further to the right of the image space adjacent to the right of the real space is defined. In this case, at the reception point 4b, as shown in a real space 405 in FIG. 5, a direct wave from the transmission point 4b, a reflected wave with one reflection, and a reflected wave with two reflections are added together for a single communication link.

A received electric field intensity E at the reception point of a communication link which includes a direct wave path and indirect wave paths is calculated as follows.

$$E = {\sum }_{i} \frac{λ}{4 π d ( i )} {e}^{- j kd ( i )} {G}_{t} ( i ) {G}_{r} ( i ) {Γ ( i )}^{m} \qquad Equation 1$$

Here, λ is a wavelength, d(i) is a path length of an i-th path, k is a wave number, Gt(i) is a transmission directivity in an i-th path direction, Gr(i) is a reception directivity in the i-th path direction, and T(i) m is a reflection coefficient in case where there are m reflections on the i-th path.

Note that, in the case of considering that the communication link also includes transmission and diffraction, the right side of Equation 1 is multiplied by a transmission coefficient and a diffraction coefficient corresponding to the number of times in addition to the reflection coefficient T. The received power is obtained by squaring an absolute value of the received electric field intensity E derived from Equation 1.

For example, in a case where there are 100 combinations of transmission candidate points and there are 100 reception points, the number of communication links within the communication area is 10,000. Assuming it takes one minute to calculate the received power from the received electric field intensity E of a communication link using Equation 1, the time required to calculate the received power at each reception point in the communication area including 10,000 communication links is approximately 167 hours. Reducing the calculation time for the indicator is desired.

A site design simulation differs from a propagation modeling simulation which aims to faithfully reproduce the propagation path. The propagation modeling involves modeling the propagation path with high precision to obtain simulation results equivalent to actual measurements. In the propagation modeling, to maximize the number of indirect waves used in the model, modeling employs the reflected wave with a large number of reflections, the transmitted wave with a large number of transmissions, and the diffracted wave with a large number of diffractions.

On the other hand, in the site design simulation, it is crucial to first determine whether or not the received power at the reception point is sufficient when the transmission point is placed at a certain transmission candidate point. The precision requirements for the simulation are less stringent in the site design compared to propagation modeling. Next, it is crucial to determine how the received power at each reception point changes when the transmission candidate point is moved to another point. The site design simulation is performed using a reflected wave with a limited number of reflections, a transmitted waves with a limited number of transmissions, and diffracted waves with a limited number of diffractions, each limited to an extent that can trace the primary path.

The calculator 56 traces the primary path among radio wave paths in the communication link. Note that, in a case where a communication link has no primary path, i.e., there is a reception point with no primary path, that reception point is considered to be in a dead zone. The calculator 56 also directly utilizes information indicating no primary path. Note that, in the propagation modeling, in a case where a communication link has zero paths, at least one of the number of reflections, the number of transmissions, or the number of diffractions is increased, the path is re-traced, and the reception status of the propagation path is re-evaluated while ensuring the number of paths.

In the propagation modeling, numerous image spaces 402, 404, and 401, as shown in FIG. 4, are defined, and the image spaces are expanded as widely as possible in the vertical, horizontal, and diagonal directions. On the other hand, the calculator 56 sets an upper limit on at least one of the number of reflections, the number of transmissions, and the number of diffractions for the paths to be traced, limits the number of image spaces to be defined, and traces the primary path.

If the primary path exists between the transmission point and the reception point, the reception point is considered to receive a radio wave of a certain intensity or higher. Instead of calculating the received electric field intensity E as shown in Equation 1 and calculating the received power using the square of the absolute value of the received electric field intensity E, the calculator 56 traces the primary path between the transmission point and the reception point and calculates the number of primary paths as the indicator.

To calculate the number of paths, the path length d (i), the wave number k, the transmission directivity Gt (i), the reception directivity Gr (i), the reflection coefficient T (i), etc. are not required. For example, to calculate the received electric field intensity E, as shown in FIG. 5, each time the path is subjected to at least one of reflection, transmission, and diffraction by an obstacle, it is necessary to calculate an angle of incidence and polarization of a wave on the obstacle and refer to electrical constants based on the material. However, such calculation is not necessary to calculate the number of paths, and therefore the calculation of the indicator is simplified.

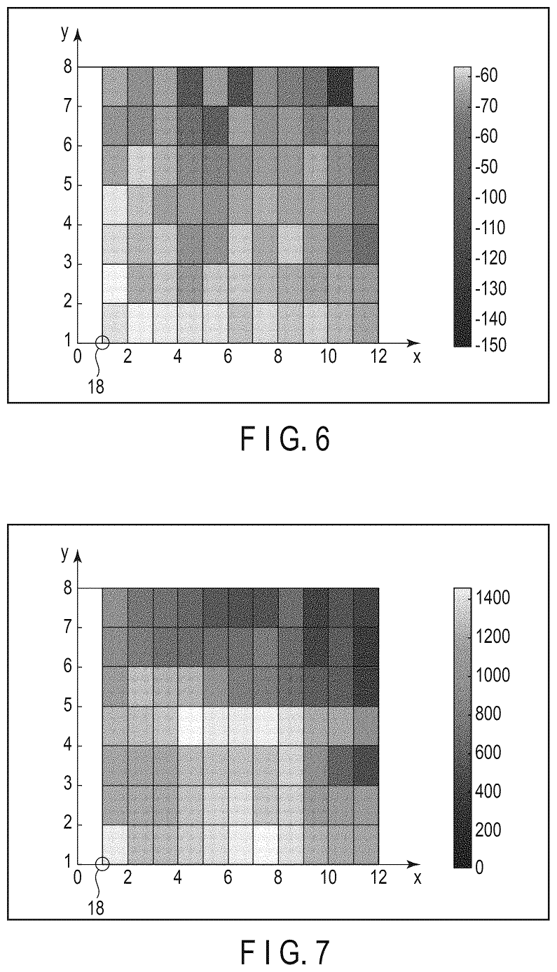

With reference to FIG. 6 to FIG. 11, an example of the relationship between the number of paths in the communication link between the transmission point and the reception point and the received power is described. Simulation conditions for the propagation path are as follows. The communication area is an office of approximately 70 m (x-axis direction)×approximately 50 m (y-axis direction)×4 m (z-axis direction). The building material of the office is concrete. The center frequency of the radio wave radiated from transmission point is 4.85 GHZ. For the path to be traced, the upper limit of the number of reflections is set to two, the upper limit of the number of transmissions is set to five, and the upper limit of the number of diffractions is set to one. The transmission candidate points are placed at a height of 3.9 m (ceiling), and the reception points are placed at a height of 1 m (ground level). The transmission candidate points and the reception points are placed at the center of a 6 m square grid area in an x-y plane. 11 grids are placed in the x-axis direction and seven in the y-axis direction. The position of the grid is represented as (m, n), m represents the m-th grid in the x-axis direction (m-th, counting from the left), and n represents the n-th grid in the y-axis direction (n-th, counting from the bottom).

FIG. 6 illustrates an example of the color map showing the received power (dB value) at all reception points within the communication area in a case where the transmission candidate point (remote unit 18) is placed at grid position (1, 1). The received power is distributed between −150 dBm and −50 dBm. Overall, the received power at reception points that are farther away from the transmission candidate point decreases with distance. However, due to the influence of structures within the communication area, the received power does not decrease monotonically.

FIG. 7 illustrates an example of the color map showing the number of paths (linear value) for all reception points within the communication area in a case where the transmission candidate point (remote unit 18) is placed at grid position (1, 1). The number of paths is distributed between zero and 1500. Similar to the color map of the received power shown in FIG. 6, although there is variation, overall, the number of paths for reception points that are farther away from the candidate transmission point decreases with distance. However, due to the influence of structures within the communication area, the number of paths does not decrease monotonically.

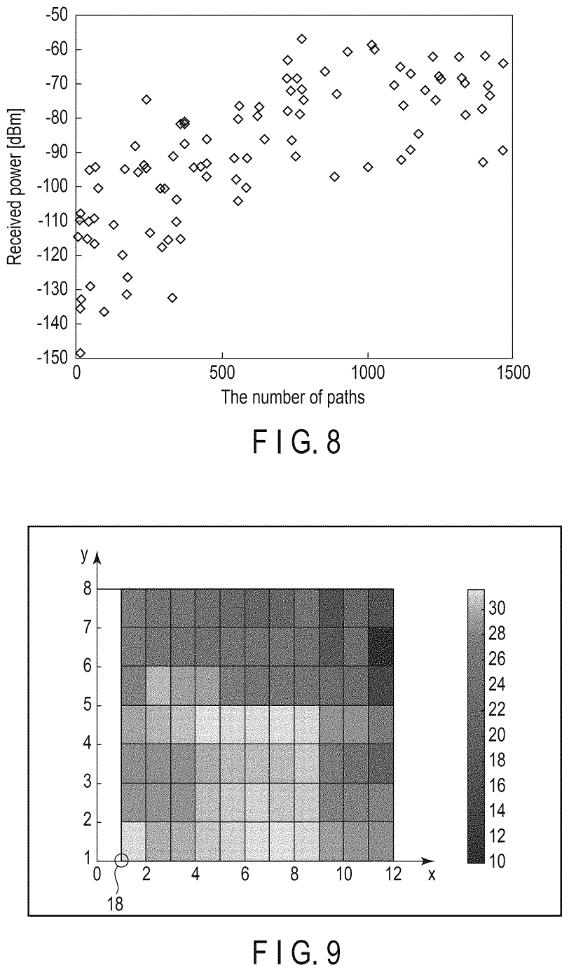

FIG. 8 illustrates an example of the correspondence relationship between the number of paths (linear value) and received power for each reception point within the communication area. A correlation exists between the number of paths and received power. Overall, reception points with fewer paths tend to have lower received power.

FIG. 9 illustrates an example of the color map showing the number of paths (logarithmic value) for all reception points within the communication area in a case where the transmission candidate point (remote unit 18) is placed at grid position (1, 1). The logarithmic value of the number of paths is 10 log 10 (number of paths). The number of paths (logarithmic value) is distributed between zero and 40. Compared to the color map of the number of paths (linear value) shown in FIG. 7, the color map of the number of paths (logarithmic value) shown in FIG. 9 shows a more pronounced similarity in the location dependency of the received power and the number of paths. The number of paths for reception points that are farther away from the transmission candidate point decreases with distance.

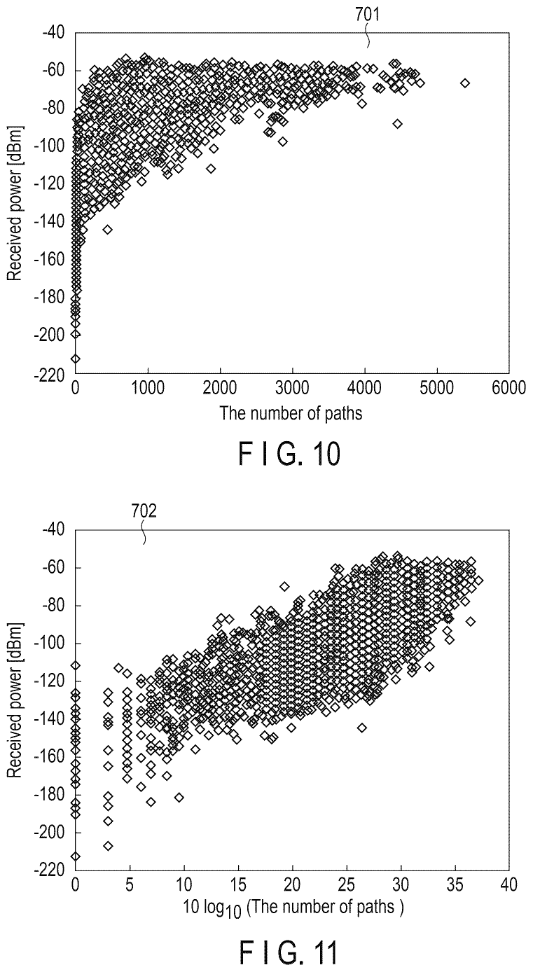

FIG. 10 and FIG. 11 illustrate an example of the correspondence relationship between the number of paths and received power for all reception points in a case where the candidate transmission point sequentially changes from grid position (1, 1) to grid position (11, 7). FIG. 10 and FIG. 11 plot the correspondence relationship between the number of paths and received power for all reception points. The number of paths in FIG. 10 is expressed by a linear value. The number of paths in FIG. 11 is expressed by a logarithmic value. The correspondence relationship shown in FIG. 11 exhibits a more pronounced correlation trend than the correspondence relationship shown in FIG. 10. The correlation coefficient for the correspondence relationship shown in FIG. 11 is 0.8091. Generally, a relationship with a correlation coefficient of 0.7 or higher indicates a strong correlation.

Therefore, since the number of paths and received power are correlated, it is appropriate to detect the reception status in the communication area based on the number of paths.

The calculator 56 calculates the number of paths instead of calculating received power as an indicator representing the reception status. By calculating the number of paths without directly calculating electric field intensity or received power, the reception status in the communication area can be detected in a short time. Furthermore, instead of calculating the number of numerous paths between transmission and reception points, the calculator 56 traces a small number of primary paths and calculates the number of primary paths. This allows the reception status of the communication area to be detected in an even shorter time. Focusing solely on the number of primary paths also allows the change in received power to be detected relatively in the case where the transmission point is changed, reducing the amount of calculation during the site design.

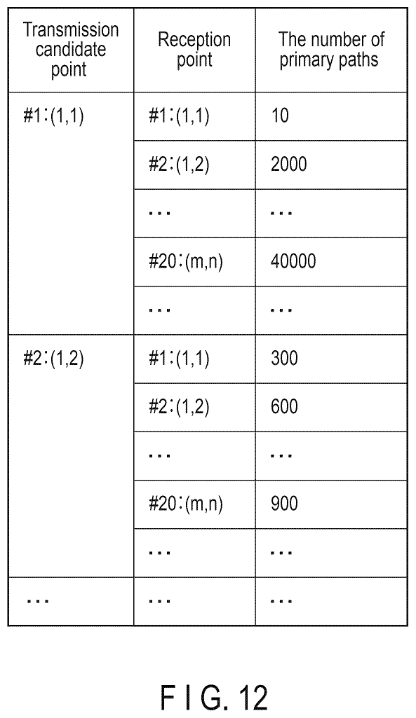

FIG. 12 illustrates an example of a table written to the memory 34 by the memory controller 60. The table correlates a grid identification number # and position (n, m) where the transmission candidate point is set, a grid identification number # and position (n, m) where the reception point is located, and the number of primary paths as an indicator.

The display controller 58 reads the table from the memory 34 and displays it on the display 40. Designers of distributed antenna systems refer to tables like the one shown in FIG. 12 to determine positions of the remote units 18 so that the overall reception status becomes favorable. In a case where the requirement of a distributed antenna system is that no dead zones with a weak received radio wave occur within the communication area, a designer may find a reception point with the minimum number of primary paths for each transmission candidate point and determine the transmission candidate point with many paths to that reception point as the position of the remote unit 18. The designer may also regard reception points with the number of primary paths below or equal to a reference number as dead zones for each transmission candidate point and determine the transmission candidate point with few or no reception points in the dead zone as the position of the remote unit 18.

The memory controller 60 may write the color map of the number of paths (logarithmic value) for each reception point within the communication area, as shown in FIG. 9, to the memory 34. Since the color map is created for each transmission candidate point, the memory controller 60 writes the color map for each combination of positions of transmission points to the memory 34.

The display controller 58 reads the color map of all transmission candidate points from the memory 34 and displays the color map on the display 40. Designers can appropriately determine the position of the remote unit 18 from the colors in the color map instead of using a table.

The calculator 56 may select transmission candidate points with a good overall reception status based on the number of primary paths between transmission and reception points. The memory controller 60 may add information representing the selected transmission candidate points to the table or the color map and write it to the memory 34. The display controller 58 may display the selected transmission candidate points on the table or the color map shown on the display 40 in a manner distinguishable from other transmission candidate points. This enables the designers to efficiently determine the position of the remote unit 18.

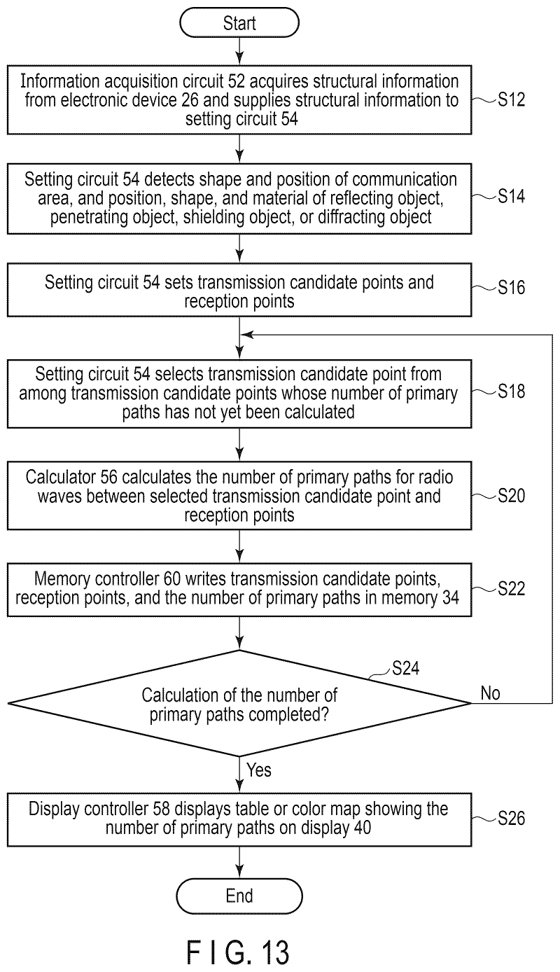

FIG. 13 is a flowchart illustrating an example of processing performed by the site design assistance program executed by an information processing device 24a. According to this program, the position of one remote unit 18 within the communication area can be determined. In the case of determining combinations of placements for the remote units 18 within the communication area, the processing in the flowchart of FIG. 13 is executed for each of the remote units 18.

The electronic device 26 is connected to the information processing device 24a via wireless or wired means. The CPU 32a of the information processing device 24a executes the site design assistance program stored in the memory 34. The information acquisition circuit 52 acquires structural information of the communication area from the electronic device 26 and supplies the structural information to the setting circuit 54 (step S12).

The setting circuit 54 detects, based on the structural information, the shape and position of the communication area, and the position, shape, and material of at least one of the reflecting object, the penetrating object, the shielding object, and the diffracting object affecting radio wave propagation within the communication area (step S14).

The setting circuit 54 sets transmission candidate points and reception points within the communication area (step S16).

The setting circuit 54 selects one transmission candidate point from among the transmission candidate points whose number of primary paths has not yet been calculated (step S18).

The calculator 56 calculates the number of primary paths for radio waves between the selected transmission candidate point and the reception points by simulation (step S20).

The memory controller 60 writes the transmission candidate points, the reception points, and the number of primary paths in correlation in the memory 34 (step S22).

The calculator 56 determines whether or not the calculation of the number of primary paths has been completed for all transmission candidate points (step S24).

In a case where the calculation of the number of primary paths has not been completed for all transmission candidate points (step S24; No), step S18 is executed, and one of the transmission candidate points for which the number of primary paths has not been calculated is selected.

In a case where the calculation of the number of primary paths has been completed for all transmission candidate points (step S24; Yes), the display controller 58 displays the table or the color map showing the number of primary paths for all reception points per transmission candidate point on the display 40 (step S26).

According to the first embodiment, radio wave propagation conditions are easily estimated by simulating the number of primary paths. The amount of calculation required for the site design is reduced. Since the number of paths is calculated by geometric optical simulation, calculations of reflection coefficient, transmission coefficient, and diffraction coefficient, etc. of the paths required for radio wave propagation modeling are omitted. Since the number of paths correlates with the received power, it is possible to utilize the indicator of the number of paths for the site design. Since the memory 34 stores numerous combinations of transmission points, reception points, and indicators, it is possible to find a combination with favorable reception status from among the numerous combinations of transmission and reception points.

### Second Embodiment

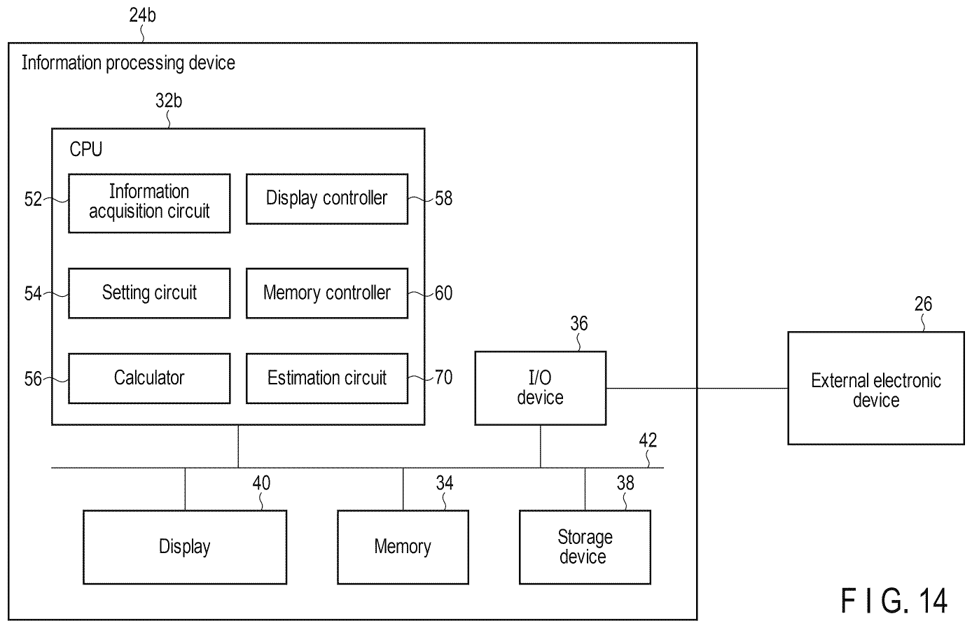

FIG. 14 is a block diagram illustrating an example of an information processing device 24b according to a second embodiment used for a site design. The information processing device 24b differs from the information processing device 24a according to the first embodiment in the configuration of the CPU 32. A CPU 32b according to the second embodiment has an estimation circuit 70 added with respect to the CPU 32a according to the first embodiment. Other configurations are identical between the information processing device 24b and the information processing device 24a.

The estimation circuit 70 estimates received power from the number of primary paths. In the site design, in a case where relative reception characteristics regarding the merits and demerits of the combinations of transmission points is desired to be detected, the information processing device 24a is used.

In the site design, there are cases where an absolute reception status is desired to be detected. For example, in private 5G, a coverage area and an adjustment target area are defined by received power. Therefore, a private 5G site design may utilize received power as an indicator. In such cases, the information processor 24b is used. The estimation circuit 70 does not calculate received electric field intensity or received power using Equation 1. Instead, the estimation circuit 70 derives received power from the logarithmic value of the number of primary paths based on a correlation coefficient between the number of paths (logarithmic value) and received power, as described in FIG. 11. The correlation coefficient is obtained by calculating the received power and the number of primary paths at two or more typical reception points in the communication area that is to be the target of the site design, and then performing regression analysis from the information. The received power increases as the number of primary paths increases.

According to the second embodiment, since the received power is not calculated directly. The received power is calculated based on the correlation coefficient derived from the number of paths. The site design that requires consideration of received power can be executed in a short time.

### Third Embodiment

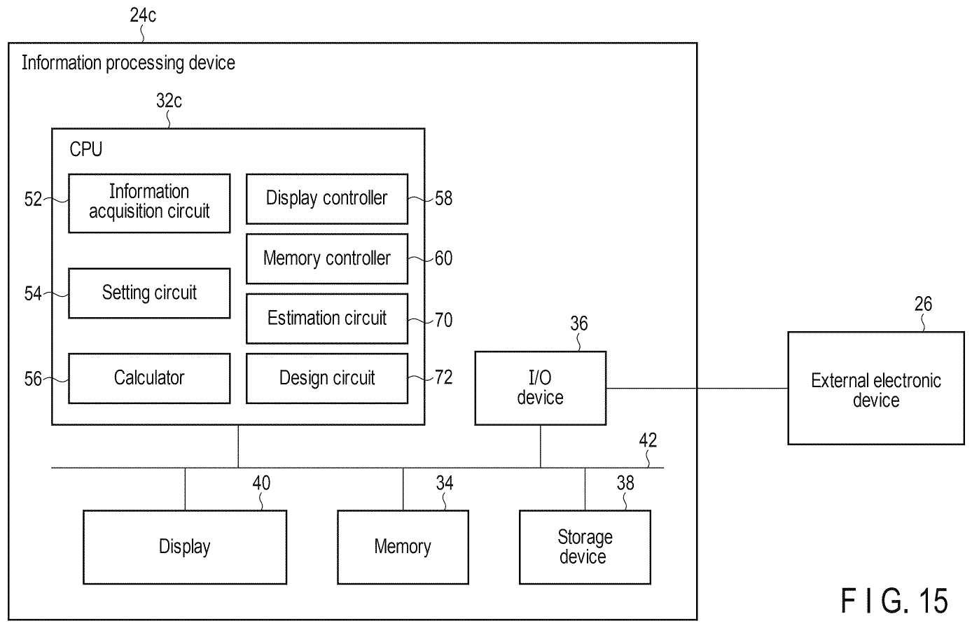

FIG. 15 is a block diagram illustrating an example of an information processing device 24c according to a third embodiment used for a site design. The information processing device 24c differs from the information processing device 24b according to the second embodiment in the configuration of the CPU 32. A CPU 32c according to the third embodiment has a design circuit 72 added with respect to the CPU 32b according to the second embodiment. Other configurations are identical between the information processing device 24c and the information processing device 24b.

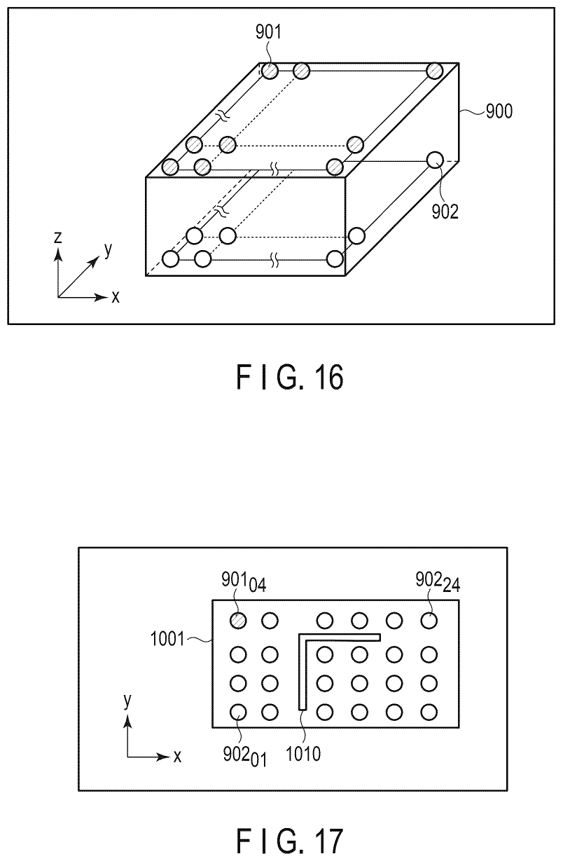

The design circuit 72 changes transmission candidate points and determines an appropriate position of the remote unit 18 based on the number of paths of each reception point. FIG. 16 illustrates, as an example of a communication area related to the design circuit 72, a room 900. Transmission candidate points 901 are set on a ceiling of the room 900. Reception points 902 are set on a floor of the room 900. FIG. 16 shows an example in an x-y plane where both the transmission candidate points 901 and the reception points 902 are positioned at center points of grids having the same shape and spacing. However, the transmission candidate points 901 and the reception points 902 may also be positioned at center points of grids having different shapes and spacings.

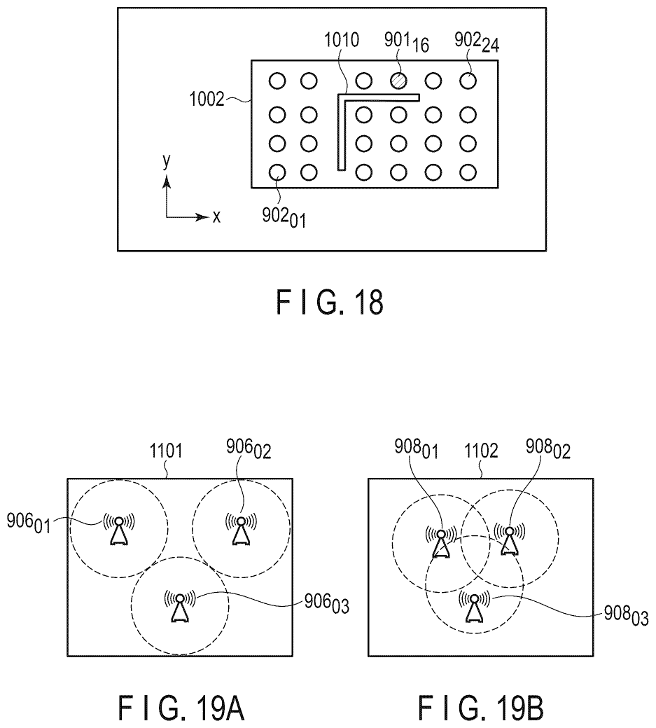

FIG. 17 and FIG. 18 show plan views of the communication area shown in FIG. 16. In a communication area 1001 shown in FIG. 17, a radio wave is radiated from a transmission candidate point 901₀₄ located at a grid #4: (1, 4). In a communication area 1002 shown in FIG. 18, a radio wave is radiated from a transmission candidate point 901₁₆ located at a grid #16: (4, 4). In a case where the communication area includes an obstacle 1010, even for the same reception point (e.g., the reception point 902₀₁ located at the grid #1: (1, 1) and the reception point 902₂₄ located at the grid #24: (6, 4)), propagation characteristics of the radio wave change depending on the presence or absence of the obstacle 1010 between the transmission point and the reception point.

The design circuit 72 detects changes in propagation characteristics based on a table such as that shown in FIG. 12. The design circuit 72 determines the position of the remote unit 18 such that the overall reception status becomes favorable, based on the number of primary paths from a first transmission candidate point located at the grid #1 to each reception point, the number of primary paths from a second transmission candidate point located at a grid #2 to each reception point, . . . , and the number of primary paths from a twenty-fourth transmission candidate point located at the grid #24 to each reception point. For example, the design circuit 72 may find the reception point with the minimum number of primary paths for each transmission candidate point and determine the transmission candidate point with many paths to that reception point as the position of the remote unit 18. The design circuit 72 may also determine the transmission candidate point with few or no reception points having the number of primary paths not larger than a reference number for each transmission candidate point as the position of the remote unit 18.

The information used by the design circuit 72 to determine the position of the remote unit 18 may be a received power instead of the number of primary paths.

According to the third embodiment, the information processing device 24c can automatically determine the position of the remote unit 18, enabling the site design to be performed in a shorter time.

### Modified Embodiment

The above description is in the case of determining the placement of a single remote unit 18 within the communication area of a distributed antenna system. However, the above embodiment is also applicable in the case of determining combinations of placements for the remote units 18 within the communication area. In that case, the aforementioned site design processing is performed for each of the remote units 18.

FIG. 19A and FIG. 19B illustrate an example of a communication area including transmission points. FIG. 19A shows a communication area 1101 of a mobile communication system that does not employ a distributed antenna system. Three radio waves with different cell IDs are radiated from three transmission points 906₀₁, 906₀₂, and 906₀₃, respectively. If a reception point within the communication area of the transmission point 906₀₁ simultaneously receives at least one of the radio wave radiated from the transmission point 906₀₂ and the radio wave radiated from the transmission point 906₀₃, interference occurs in the received signal. Therefore, the number of primary paths for the reception point of the transmission point 906₀₁ includes paths of the communication link only to the transmission point 906₀₁. That is, the number of paths for the reception point is counted independently for each transmission point of the cell where the reception point is located.

FIG. 19B shows a communication area 1102 of the distributed antenna system. Three radio waves with the same cell ID are radiated from three transmission points 908₀₁, 908₀₂, and 908₀₃, respectively. Even if a reception point within the communication area of transmission point 908₀₁ simultaneously receives at least one of the radio waves radiated from the other transmission points 908₀₂ and 908₀₃ along with the radio wave radiated from transmission point 908₀₁, no interference occurs in the received signal. Therefore, the number of primary paths for the reception point of transmission point 908₀₁ includes all paths of the three communication links with all transmission points 908₀₁, 908₀₂, and 908₀₃. That is, the number of paths for the reception point is counted by adding up the number of paths for all transmission points.

The information processing device according to the embodiment can also be used for the site design in mobile communication systems other than distributed antenna systems.

The above description relates to a mobile communication system where a ceiling-side remote unit 18 is the transmission point and a ground-side terminal 20 is the reception point. However, since radio wave propagation is reversible, the transmission point and the reception point may be interchanged. It is also applicable to the site design of a communication system where the terminal 20 is the transmission point and the remote unit 18 is the reception point. The positions of the remote units 18 are determined so that all remote units 18 can comprehensively receive the radio wave from any terminal 20 located within the communication area with good quality.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A non-transitory computer-readable storage medium storing a computer-executable program that, when executed, causes the computer to perform following steps of:
acquiring structural information of a radio wave irradiation area;
setting at least one transmission point and at least one reception point within the irradiation area;
calculating the number of first paths within radio wave paths between the at least one transmission point and the at least one reception point; and
outputting reception status information of the at least one reception point based on the number of the first paths.

2. The non-transitory computer-readable storage medium of claim 1, wherein the calculating comprises:
calculating the number of the first paths geometrically based on the structural information, a position of the at least one transmission point, and a position of the at least one reception point.

3. The non-transitory computer-readable storage medium of claim 1, wherein the computer-executable program causes the computer to further perform a step of:
writing the number of the first paths in connection with the at least one transmission point and the at least one reception point into a memory.

4. The non-transitory computer-readable storage medium of claim 1, wherein the computer-executable program causes the computer to further perform a step of:
estimating a received power of a radio wave at the at least one reception point based on the number of the first paths.

5. The non-transitory computer-readable storage medium of claim 4, wherein the estimating comprises:
estimating the received power based on a correlation between logarithm of the number of the radio wave paths and a decibel value of the received power.

6. The non-transitory computer-readable storage medium of claim 1, wherein
the at least one transmission point comprises transmission points, and
the computer-executable program causes the computer to further perform a step of:
determining a first transmission point among the transmission points based on the number of the first paths of the at least one reception point for each of the transmission points.

7. The non-transitory computer-readable storage medium of claim 6, wherein the determining comprises:
determining the first transmission point so that there is no reception point for which the number of the first paths is smaller than a first number for each of the transmission points.

8. The non-transitory computer-readable storage medium of claim 6, wherein
the at least one transmission point comprises a first transmission point and a second transmission point that transmit the same signal, and
the determining comprises determining the first transmission point among the transmission points based on a sum of the number of the first paths for the at least one reception point for the first transmission point and the number of the first paths for the at least one reception point for the second transmission point.

9. The non-transitory computer-readable storage medium of claim 1, wherein the structural information comprises information representing at least one of a position, a shape, and a material of an object affecting propagation of a radio wave in the irradiation area.

10. The non-transitory computer-readable storage medium of claim 9, wherein the object comprises at least one of a reflecting object that reflects the radio wave, a penetrating object through that the radio wave penetrates, a shielding object that blocks the radio wave, and a diffracting object that diffracts the radio wave.

11. The non-transitory computer-readable storage medium of claim 1, wherein the reception status information comprises information indicating that the number of the first path is zero.

12. The non-transitory computer-readable storage medium of claim 1, wherein the first path comprises at least one of a path where the number of reflections is not larger than a first value, a path where the number of transmissions is not larger than a second number, and a path where the number of diffractions is not larger than a third number.

13. The non-transitory computer-readable storage medium of claim 1, wherein the reception status information comprises information representing the received power of the radio wave at the at least one reception point.

14. The non-transitory computer-readable storage medium of claim 13, wherein the reception status information indicates that the received power increases as the number of the first paths increases.

15. The non-transitory computer-readable storage medium of claim 1, wherein the reception status information comprises information in which the first path does not exist.

16. The non-transitory computer-readable storage medium of claim 1, wherein the reception status information comprises a table showing the at least one transmission point, the at least one reception point, and the received power in connection with each other.

17. The non-transitory computer-readable storage medium of claim 1, wherein the reception status information comprises a color map representing the received power of the radio wave at the at least one reception point within the irradiation area by color differences.

18. An information processing device comprises a processor configured to:
acquire structural information of a radio wave irradiation area;
set at least one transmission point and at least one reception point within the irradiation area;
calculate the number of first paths within radio wave paths between the at least one transmission point and the at least one reception point; and
output reception status information of the at least one reception point based on the number of the first paths.

19. An information processing method comprising:
acquiring structural information of a radio wave irradiation area;
setting at least one transmission point and at least one reception point within the irradiation area;
calculating the number of first paths within radio wave paths between the at least one transmission point and the at least one reception point; and
outputting reception status information of the at least one reception point based on the number of the first paths.
